(19) United States
(12) Patent Application Publication
(10) Pub. No.: US 2014/0265733 A1
(43) Pub. Date: Sep. 18, 2014

(54) FLEXURE-ENHANCING SYSTEM FOR IMPROVED POWER GENERATION IN A WIND-POWERED PIEZOELECTRIC SYSTEM

(71) Applicant: Arjun Balasingam, San Jose, CA (US)

(72) Inventor: Arjun Balasingam, San Jose, CA (US)

(21) Appl. No.: 13/842,203

(22) Filed: Mar. 15, 2013

(51) Int. Cl. H02N 2/18

(52) U.S. Cl. CPC H02N 2/185
USPC 310/339

(57) ABSTRACT

Improving wind-based piezoelectric power conversion is provided. For example, a piezoelectric element affixed to a vibratory member is provided. A rigid mounting system is provided for said vibratory member on one end of the vibratory member. At least one obstacle is provided located on the flexing side of the vibratory member. The obstacle induces a vortex in the wind passing the obstacle and arriving at the vibratory member, which enhances wind-induced displacement in the vibratory member.

### FIELD OF THE INVENTION

The present invention relates to a piezoelectric power generation device with an enhanced power output as compared to more conventional devices.

### BACKGROUND

Wind-powered piezoelectric devices are known to produce small amounts of power, thus requiring many piezoelectric devices to recharge a battery in a given amount of time. There is a need to significantly enhance the power output by a given piezoelectric device.

### BRIEF DESCRIPTION OF THE DRAWINGS

The accompanying drawings, which are incorporated in and form a part of this Description of Embodiments, illustrate various embodiments of the present invention and, together with the description, serve to explain principles discussed below:

FIG. 1 depicts a piezoelectric power source that is affixed to a flexible sheet, which is in turn attached to a support rod, according to one embodiment.

FIG. 2 depicts a top view of a device, showing vortex action with a single bluff obstacle, according to one embodiment.

FIG. 3 depicts a top view of a device, showing vortex action with 2 bluff obstacles, according to one embodiment.

FIG. 4 depicts an image of a working model of a twin bluff obstacle of the invention, according to one embodiment.

FIG. 5 depicts a top view for bluff obstacle cross sections, according to one embodiment.

FIG. 6 depicts a device with the end of the fin is augmented with a short perpendicular plate, according to one embodiment.

FIG. 7 depicts a flowchart of a method for improving wind-based piezoelectric power conversion, according to one embodiment.

The drawings referred to in this Brief Description should not be understood as being drawn to scale unless specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Wind-powered piezoelectric devices are known to produce small amounts of power, thus requiring many piezoelectric devices to recharge a battery in a given amount of time. The power output of a given piezoelectric device can be enhanced significantly by increasing the amount of flexure the piezoelectric device experiences for a given wind speed, according to various embodiments. There are many configurations for arranging to induce flexure in a piezoelectric power generator. Baseline power outputs are often measured in the microwatt region, with 8 microwatts being typical. However, ganging multiple piezoelectric devices on a single flexible mounting system increases power, but at a small rate.

According to various embodiments, A piezoelectric power generating device is affixed to a thin brass sheet, which in turn is mounted to a support rod at one end of the sheet. For example, when the plane of the brass sheet is aligned with the direction of incoming wind, the sheet can vibrate by itself, due to small differences in wind arrival direction. The amplitude of these vibrations can be enhanced dramatically by introducing a vortex-inducing obstacle in the path of the wind. The increased turbulence associated with the vortex causes much larger displacements of the thin brass sheet, thereby inducing greater flexure in the sheet and thus in the piezoelectric device, according to an embodiment. Therefore, according to various embodiments, this is a flexural enhancing system for a piezoelectric wind-powered source.

According to various embodiments, any suitable flexible material may be used for the vibratory fin. For example, a plastic sheet, a carbon-fiber sheet, or any other metallic sheet with sufficient flexural bending without cracking can be used. According to one embodiment, the thickness for a brass sheet is 0.032 in. For example, the size of the sheet may be 4 inches by 10 inches. However, various embodiments do not depend on a 4 inch by 10 inch size, and, therefore, the size can be adjusted to suit the user's needs.

The piezoelectric device can be mounted at the constrained end of the fin so that this first end of the piezoelectric device is not able to move, according to one embodiment. The other end can move when the fin is deflected in either direction about the axis of the supporting post by the wind, as shown in FIG. 2 and FIG. 3, according to one embodiment. For example, as shown in FIG. 2, the piezoelectric device can experience a bending moment as the fin is displaced in either direction from the rest position.

FIG. 1 depicts a piezoelectric power source 102 that is affixed to a flexible sheet 101, which is in turn attached to a support rod 104, according to one embodiment.

For example, the support rod may be mounted in an anchoring system, not shown. The electric current can be generated by the piezoelectric power source 102 that is conveyed to a battery 105 to charge the battery. In an embodiment, suitable power conditioning (not shown) may be inserted between the piezoelectric source and the storage device.

The flexible vibratory member 101, also referred to as the fin, can vibrate in any wind, to some extent, due to the natural variation in angle of arrival of the airflow associated with wind, which is usually quite random, according to one embodiment. Therefore, the normal wind at 3-15 km/hr, for example, will demonstrate laminar flow, to a large extent, so the degree of vibration and displacement will depend on the variation in angle of arrival as well as the wind speed, according to various embodiments.

Non-laminar flow may simultaneously create a wider range of angle of arrival, as well as a higher velocity, according to various embodiments. This observation can lead to seeking passive ways to improve non-laminar flow, according to various embodiments. For example, non-laminar flow is introduced by placing an obstacle in the path of the airflow. An obstacle may consist of a cylindrical object, located a few inches away from the end of the vibratory member, as shown in FIG. 1 at obstacle 103. Obstacles are often referred to as a bluff. The bluff can produce a vortex of air in which air current paths are more variable than is the case with laminar flow, according to one embodiment.

FIG. 2 depicts a top down view of the power generator system fin, support, and piezoelectric element, and the single cylindrical bluff obstacle, according to one embodiment. For example, as depicted in FIG. 2, the wind 210 impinges on the bluff and is diverted around it, causing non-laminar flow, in a vortex, as indicated by the lines of airflow at 220. This airflow causes greater displacements of the end of the fin 101, thus inducing greater displacement in the piezoelectric device, and therefore producing more electricity at a higher voltage, and delivering more current, according to various embodiments.

The vortex-inducing obstacle can be augmented by using two bluffs, for example, located on either side of the plane of the fin at rest, a short distance away from the plane centerline of the fin, according to one embodiment. Experimental results indicate that the size of the cylindrical bluff is not critical to obtaining the improvements observed. In an embodiment, alternate bluff cross sections may be employed, as shown in FIG. 5, in which eight such different cross sections are depicted: triangle 501, square 502, rounded corner square 503, diamond square 504, trapezoid 505, pentagon 506, hexagon 507, and octagon 508.

A baseline power level from an unmodified fin is found to be approximately 8 micowatts, according to one embodiment. Locating the two bluffs on radial lines from the post at a 30 degree offset, just past the end of the fin at rest, can deliver approximately 1.5 milliwatts, which is a dramatic improvement, according to various embodiments.

In an embodiment depicted in FIG. 6, an additional improvement in output power level can be obtained by adding a plate to the end of the fin at 606. As depicted in FIG. 6, according to various embodiments, the width of the additional plate is approximately 1 in. FIG. 6 shows a single bluff obstacle 603, but two such bluffs may also be used, as was shown in FIG. 3.

According to one embodiment, moving the two bluffs outward slightly from the centerline of the fin at rest, on a radial of 50 degrees each from the axis of the fin, can produce an even better result, with 3.9 mW, for example. This is a significant enough number to provide charging for batteries used to power remote data collection systems, according to various embodiments.

FIG. 7 depicts a flowchart 700 of a method for improving wind-based piezoelectric power conversion, according to one embodiment.

At 710, the method begins.

At 720, a piezoelectric element affixed to a vibratory member is provided.

For example, the piezoelectric element can be connected to a battery for capturing electric current created by the flexing of the piezoelectric element on the vibratory member. The vibratory member may be a cantilevered brass fin. The cantilevered brass fin may further comprise a second element mounted at the displacing end, also known as the flexing end, of the vibratory member and perpendicular to the plane of the vibratory member

At 730, a rigid mounting system for said vibratory member on one end of the vibratory member is provided.

At 740, at least one obstacle located on the flexing side of the vibratory member is provided, where the obstacle induces a vortex in the wind passing the obstacle and arriving at the vibratory member, which enhances wind-induced displacement in the vibratory member. For example, the obstacle may be cylindrical. The obstacle may be located parallel to the plane of the vibratory member. The obstacle may comprise two cylinders located on either side of the plane of the vibratory member. The two cylinders may be located near the unsupported end of the vibratory member.

At 750, the method ends.

Although specific operations are disclosed with respect to flowchart 700 provided according to various embodiments, such operations are exemplary. That is, embodiments of the present invention are well suited to performing various other operations or variations of the operations recited in flowchart 700. It is appreciated that the operations in flowchart 700 may be performed in an order different than presented, and that not all of the operations in flowchart 700 may be performed.

The blocks that represent features in FIGS. 1-6 can be arranged differently than as illustrated, and can implement additional or fewer features than what are described herein. Further, the features depicted in FIGS. 1-6 can be combined in various ways.

A flexure-enhancing system for augmenting the displacement of a wind-powered piezoelectric generator system is disclosed, according to various embodiments. For example, the piezoelectric generator system can comprise a piezoelectric source mounted to a thin flexible sheet and affixed to a mounting system. As the wind blows, the thin sheet is deflected causing the piezoelectric source to flex, and thus product electricity, according to one embodiment. Flexure enhancement can be achieved via the use of a vortex-inducing bluff obstacle placed in the path of wind. Two such bluff obstacles can be used to further improve performance. The enhanced power output occurs because of an enhanced flexural system, according to one embodiment. The greater the displacement or bending of a piezoelectric device, the greater the power output, according to one embodiment.

Various embodiments have been described in various combinations. However, any two or more embodiments may be combined. Further, any embodiment may be used separately from any other embodiments.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims.

What is claimed is:

1. A method for improving wind-based piezoelectric power conversion, comprising:
providing a piezoelectric element affixed to a vibratory member;
providing a rigid mounting system for said vibratory member on one end of the vibratory member; and
providing at least one obstacle located on the flexing side of the vibratory member, wherein the obstacle induces a vortex in the wind passing the obstacle and arriving at the vibratory member, which enhances wind-induced displacement in the vibratory member.

2. The method of claim 1 wherein the piezoelectric element is connected to a battery for capturing electric current created by the flexing of the piezoelectric element on the vibratory member.

3. The method of claim 1 wherein the obstacle is cylindrical.

4. The method of claim 1 wherein the obstacle is located parallel to the plane of the vibratory member.

5. The method of claim 1 wherein the obstacle comprises two cylinders located on either side of the plane of the vibratory member.

6. The method of claim 5 wherein the two cylinders are located near the unsupported end of the vibratory member.

7. The method of claim 1 wherein the vibratory member comprises a cantilevered brass fin.

8. The method of claim 7 wherein the cantilevered brass fin further comprises a second element mounted at the displacing end of the vibratory member and perpendicular to the plane of the vibratory member.

9. A flexural enhancing system for improving power output of a wind-powered piezoelectric generator, comprising:
a piezoelectric crystal mounted on a flexible vibratory member;
a rigid mounting/support system affixed to one end of said flexible vibratory member; and
an obstacle located adjacent to the flexing end of the vibratory member for inducing a vortex in the wind passing the obstacle and inducing a vortex in the wind, thereby enhancing the displacement of the flexible vibratory member, which causes the piezoelectric power generator to produce more power.

10. The flexural enhancing system of claim 9 wherein the obstacle comprises a cylinder whose main axis is parallel to the plane of the vibratory member and is located adjacent to the flexing end of the vibratory member.

11. The flexural enhancing system of claim 9 wherein the obstacle comprises two cylinders whose main axes are parallel to the plane of the vibratory member and are mounted on either side of the plane of the vibratory member, near the flexing end of the vibratory member.

12. The flexural enhancing system of claim 9 wherein the obstacle cross section is selected from the group consisting of: a triangle, a square, a pentagon, a hexagon, an octagon, and a polygon.

13. The flexural enhancing system of claim 9 wherein the flexible vibratory member is augmented with a flat plate mounted at the unsupported end and is perpendicular to the plane of the vibratory member.
